(19) United States
(12) Patent Application Publication
(10) Pub. No.: US 2026/0163944 A1
(43) Pub. Date: Jun. 11, 2026

(54) DOWNLOADING DATA BASED ON PRIORITIES FOR VEHICLE SYSTEMS

(71) Applicant: TOYOTA JIDOSHA KABUSHIKI KAISHA, Aichi-ken (JP)

(72) Inventors: Keisuke SAWADA, Edogawa-ku (JP); Mitsuo Date, Funabashi-shi (JP)

(21) Appl. No.: 18/977,774

(22) Filed: Dec. 11, 2024

(51) Int. Cl. H04L 67/12; H04L 67/61

(52) U.S. Cl. CPC H04L 67/12; H04L 67/61

(57) ABSTRACT

Downloading data based on priorities is performed by receiving, by a mobile computing network in a vehicle, a first download request; receiving, by the mobile computing network, a second download request; determining a priority level associated with each of the first download request and the second download request based on a data type; and performing downloads of the first download request and the second download request in sequence based on the associated priority level.

### BACKGROUND

Modern vehicles are becoming increasingly connected with external systems (e.g., cloud servers, traffic management systems, other vehicles, etc.) via wireless technologies like cellular networks, Wi-Fi, and satellite links. In modern connected vehicles, data comes from multiple sources and is used for various purposes, ranging from safety-critical functions to improving the user experience.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a system for downloading data based on priorities, according to at least one embodiment of the subject disclosure.

FIG. 2 is an operational flow for downloading data based on priorities, according to at least one embodiment of the subject disclosure.

FIG. 3 is an operational flow for determining priority levels associated with download requests based on data types, according to at least one embodiment of the subject disclosure.

FIG. 4 is an operational flow for performing downloads in sequence based on associated priority levels, according to at least one embodiment of the subject disclosure.

FIG. 5 is an operational flow for comparing priority levels of download requests, according to at least one embodiment of the subject disclosure.

FIG. 6 is a block diagram of a hardware configuration for downloading data based on priorities, according to at least some embodiments of the subject disclosure.

FIG. 7 is a table of an example of data types, according to at least one embodiment of the subject disclosure.

FIG. 8 is a table of an example of priority matrix, according to at least one embodiment of the subject disclosure.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

When multiple types of data need to be downloaded simultaneously, prioritization enables the most important and time-sensitive data to get delivered first, while maintaining safety, functionality, and efficiency. The ability to manage this data flow effectively is central to the performance and safety of advanced vehicle systems. The connectivity between modern vehicles with external servers via wireless technologies allows vehicles to receive real-time information, such as: navigation data (e.g., map data, route search results, surrounding information), traffic condition data (e.g., congestion reports, accident alerts), remote operation data and diagnostics (e.g., key lock/unlock, air conditioner on/off, alarm activation, battery status, vehicle health checks), software updates (e.g., for infotainment systems, safety features, autonomous driving software), weather data (e.g., forecasts for route planning), user-specific data related to vehicle management (e.g., settings for seats, mirrors, climate control, account authentication, database of voice recognition), entertainment data (e.g., music, video, image, web search), as well as emergency related data (e.g., emergency call, security patch). However, downloading multiple types of data at once can strain a vehicle's connectivity and processing resources. When a vehicle receives multiple download requests, such as receiving a request to download information about a point of interest (POI) while downloading a music stream, the vehicle cannot simultaneously perform multiple downloads. Instead, the vehicle must perform a download completely before proceeding to perform another download. In the example of a music stream, performance of the download may never complete until the download request is canceled. Therefore, effective data prioritization is beneficial in enabling important updates to be processed first, so that the vehicle remains safely and efficiently operable. Prioritization also helps manage bandwidth limitations (e.g., cellular network speed, Wi-Fi range) to enable the vehicle to receive relevant information.

In at least some embodiments described herein, the solution to the above-mentioned problem is to download data based on priorities. That is, when a vehicle receives multiple download requests, downloads are performed in an order based on a priority level assigned to each download request based on the type of data of each download request. In this way, multiple downloads are performed by the vehicle in an appropriate order.

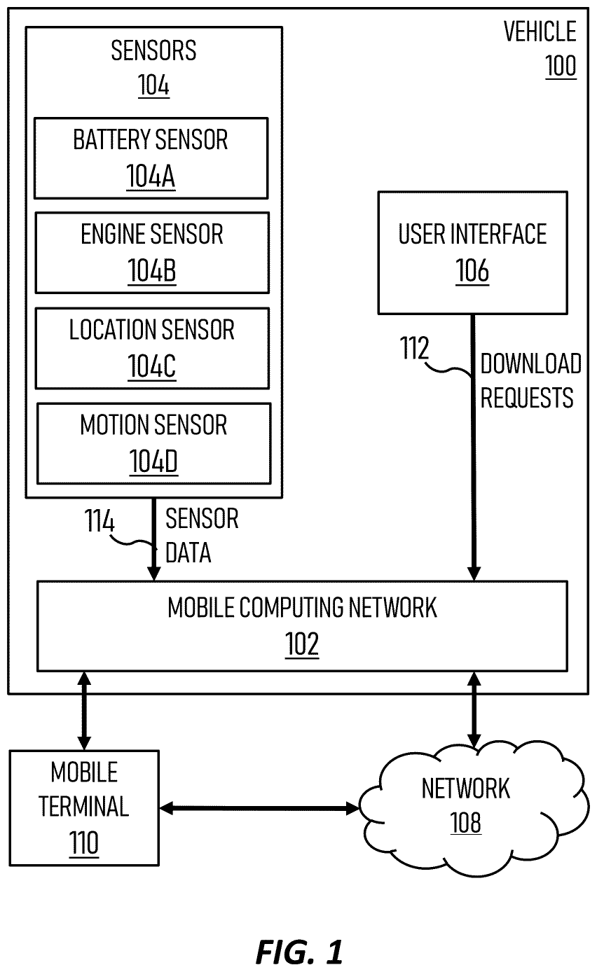

FIG. 1 is a schematic diagram of a system for downloading data based on priorities, according to at least one embodiment of the subject disclosure. The system includes a plurality of sensors 104, and a user interface 106 connected to a mobile computing network 102 within a vehicle 100. Vehicle 100 is further in communication with a mobile terminal 110 and a network 108 through mobile computing network 102. Sensors 104 include a battery sensor 104A, an engine sensor 104B, a location sensor 104C and a motion sensor 104D. Sensors 104 are configured to transmit sensor data 114 to mobile computing network 102. Mobile terminal 110 is in communication with network 108. User interface 106 is configured to transmit download requests 112 to mobile computing network 102. In at least some embodiments, mobile computing network 102, sensors 104, and user interface 106 are parts of a single device, such as vehicle 100.

In at least some embodiments, vehicle 100 is configured to transmit notifications and instructions to mobile terminal 110, and to receive an application from mobile terminal 110. In at least some embodiments, vehicle 100 is in communication with mobile terminal 110 through mobile computing network 102. In at least some embodiments, vehicle 100 is in communication with mobile terminal 110 through network 108. In at least some embodiments, vehicle 100 is an automobile or an autonomous vehicle.

In at least some embodiments, mobile computing network 102 is configured to receive download requests 112 from user interface 106, and to receive sensor data 114 from sensors 104. In at least some embodiments, mobile computing network 102 is an integration of wireless communication technologies and computing systems within vehicle 100 to support a variety of connected services, applications, and functions. In at least some embodiments, mobile computing network 102 is configured to enable vehicle 100 to interact with external systems (e.g., the internet, cloud services, other vehicles, or infrastructure), as well as support on-board systems that enhance the driving experience, safety, navigation, and overall functionality of vehicle 100. In at least some embodiments, mobile computing network 102 is a Controller Area Network (CAN), an Ethernet network, a Peripheral Component Interconnect Express (PCIe) network, a Universal Serial Bus (USB) network, or a Local Internet Network (LIN).

Sensors 104 are configured to transmit sensor data 114 to mobile computing network 102. Sensors 104 include battery sensor 104A, engine sensor 104B, location sensor 104C and motion sensor 104D. In at least some embodiments, data types of sensor data 114 provided by battery sensor 104A, engine sensor 104B, location sensor 104C and motion sensor 104D are different. In at least some embodiments, battery sensor 104A is configured to detect a remaining capacity of a vehicle battery. In at least some embodiments, battery sensor 104A is configured to detect whether a charging operation is applied to the vehicle battery. In at least some embodiments, battery sensor 104A is configured to detect whether vehicle 100 is in a power saving mode. In at least some embodiments, engine sensor 104B is configured to detect if vehicle 100 is in a power-on state or a power-off state. In at least some embodiments, location sensor 104C is configured to detect a geographic location of vehicle 100. In at least some embodiments, location sensor 104C is configured to determine a precise position, orientation, and movement of vehicle 100 in real-time. In at least some embodiments, location sensor 104C is a GPS (Global Positioning System), an accelerometer, a gyroscope, a compass, etc. In at least some embodiments, motion sensor 104D is configured to detect a vehicle state of vehicle 100. In at least some embodiments, the vehicle state indicates whether vehicle 100 is running or stopped. In at least some embodiments, motion sensor 104D is configured to detect and measure the movement or acceleration of vehicle 100. In at least some embodiments, motion sensor 104D is configured to measure acceleration, angular velocity, and directional changes of vehicle 100. In at least some embodiments, motion sensor 104D is an accelerometer, a gyroscope, an Inertial Measurement Unit (IMU), a radar sensor, or a camera-based system.

User interface 106 is configured to transmit download requests to mobile computing network 102. In at least some embodiments, user interface 106 is configured to enable drivers, passengers, and other users to interact with the vehicle's various systems, technologies, and features. In at least some embodiments, user interface 106 is configured to enable selection of one location to perform all downloads or individual locations for certain downloads or downloads of certain data types. In at least some embodiments, user interface 106 is a smartphone, a touchscreen display, a voice control system, a Heads-Up Display (HUD), a gesture control, or a mobile integration and connectivity system. In at least some embodiments, user interface 106 is external to the vehicle.

In at least some embodiments, network 108 is configured to enable communications between mobile terminal 110 and mobile computing network 102 of vehicle 100. In at least some embodiments, network 108 is configured to connect vehicle 100 with external systems, other vehicles, or the cloud. In at least some embodiments, network 108 is configured to enable real-time data exchange, remote diagnostics, entertainment features, and advanced driver assistance systems (ADAS). In at least some embodiments, network 108 is a wired network, a 4G LTE network, a 5G network, or a Wi-Fi network that allows Vehicle-to-Vehicle (V2V) communication or Vehicle-to-Everything (V2X) communication.

Mobile terminal 110 is configured to communicate with vehicle 100 through mobile computing network 102 or network 108. In at least some embodiments, mobile terminal 110 is configured to receive notifications from vehicle 100. In at least some embodiments, mobile terminal 110 is configured to transmit applications to vehicle 100. In at least some embodiments, mobile terminal 110 is a portable device that is configured to connect to networks and exchange data. In at least some embodiments, mobile terminal 110 is a smartphone, a tablet, a smartwatch, a portable laptop, or smart glasses.

Download requests 112 are transmitted by user interface 106 to mobile computing network 102. In at least some embodiments, download requests 112 include requests for downloading applications or data related to operating system updates, entertainment, navigation, vehicle management, security and emergency, etc. In at least some embodiments, entertainment data includes music data, video data, and image data, etc. In at least some embodiments, navigation data includes map data, route search result data (if route search is performed in a server), surrounding information, and traffic conditions, etc. In least some embodiments, vehicle management data includes key lock/unlock, air conditioner on/off, and alarm activation, etc. In at least some embodiments, security data includes security patches. In at least some embodiments, emergency data includes emergency calls. In at least some embodiments, download requests 112 include requests for downloading applications or data related to web searches, account authentications, and database of voice recognitions, etc.

Sensor data 114 is transmitted by sensors 104 to mobile computing network 102. In at least some embodiments, sensor data 114 includes data of different data types, which are detected by different sensors of sensors 104. In at least some embodiments, the types of data are different depending on the sensor design. In at least some embodiments, sensor data 114 includes vehicle battery status data, vehicle state data, geographic location data, etc.

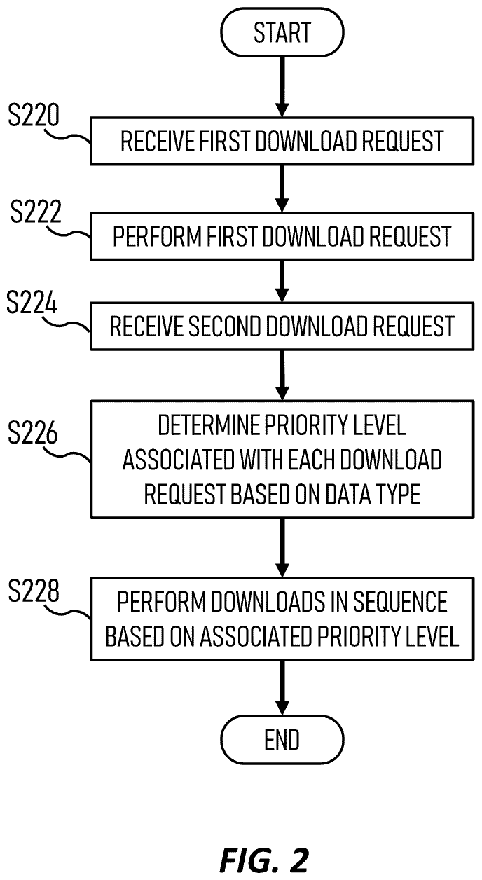

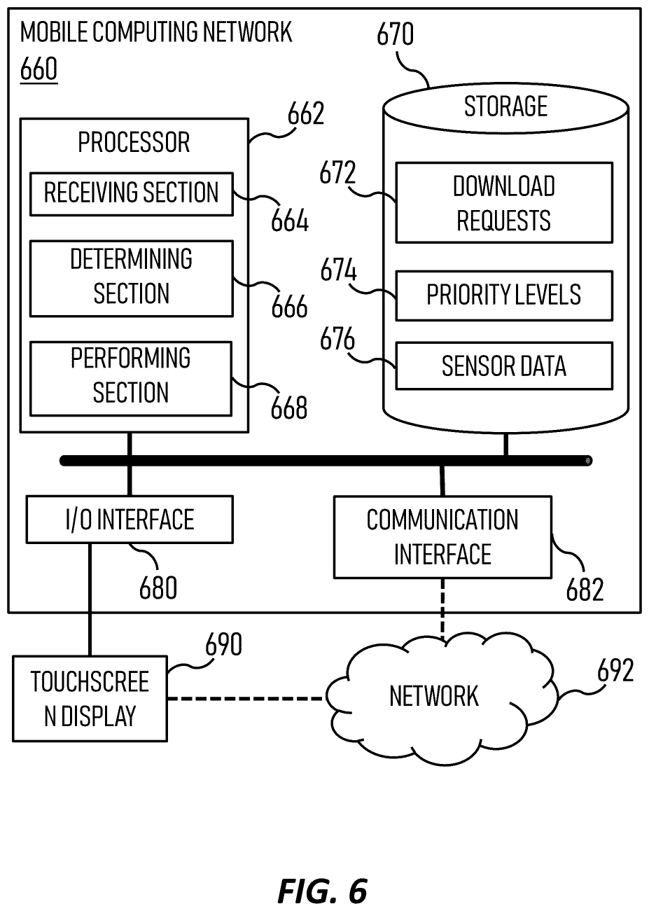

FIG. 2 is an operational flow for downloading data based on priorities, according to at least one embodiment of the subject disclosure. The operational flow provides a method of downloading data based on priorities. In at least some embodiments, the method is performed by a vehicle, such as vehicle 100 shown in FIG. 1, or a processor of an integrated circuit including sections for performing certain operations, such as the processor 662 shown in FIG. 6, which will be explained hereinafter.

At S220, a receiving section of the processor receives a first download request. In at least some embodiments, the receiving section receives the first download request by a mobile computing network. In at least some embodiments, the first download request includes downloading applications or data related to operating system updates, entertainment, navigation, vehicle management, security and emergency, etc.

At S222, a performing section of the processor performs the first download request. In at least some embodiments, the performing section performs a download of the first download request before receiving a second download request. In at least some embodiments, the performing section performs the download of the first download request based on a priority level of the first download request.

At S224, the receiving section of the processor receives the second download request. In at least some embodiments, the receiving section receives the second download request by the mobile computing network. In at least some embodiments, the second download request includes downloading applications or data related to operating system updates, entertainment, navigation, vehicle management, security and emergency, etc.

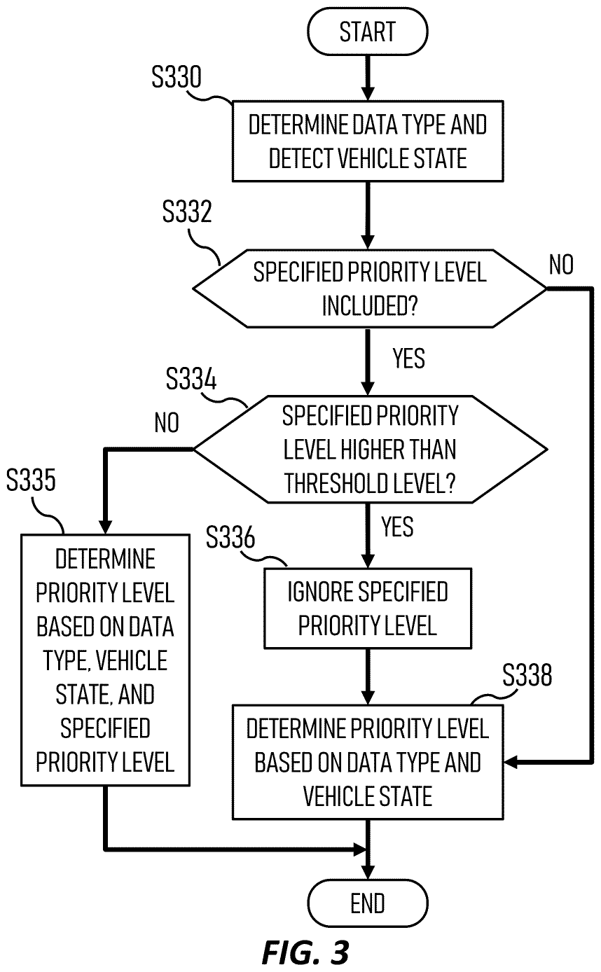

At S226, a determining section of the processor determines a priority level associated with each download request based on a data type. In at least some embodiments, the determining section determines the priority level associated with each of the first download request and the second download request based on the data type. In at least some embodiments, the determining section determines the priority level based on a vehicle state. In at least some embodiments, the vehicle state is one of running or stopped. In at least some embodiments, the determining section performs the operational flow shown in FIG. 3, which will be explained hereinafter.

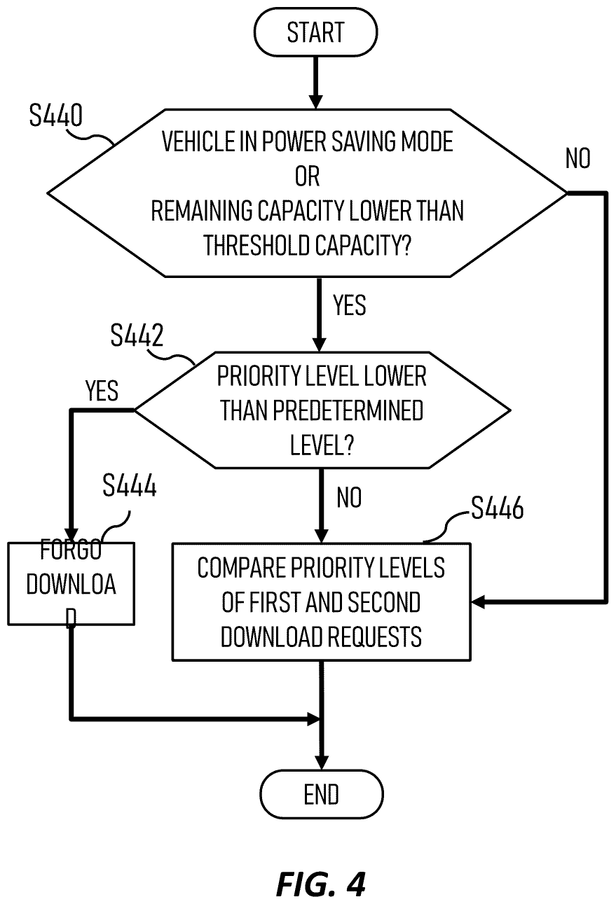

At S228, the performing section of the processor performs downloads in sequence based on associated priority level. In at least some embodiments, the performing section performs downloads of the first download request and the second download request in sequence based on the associated priority level. In at least some embodiments, the performing section performs the operational flow shown in FIG. 4, which will be explained hereinafter.

FIG. 3 is an operational flow for determining priority levels associated with download requests based on data types, according to at least one embodiment of the subject disclosure. The operation flow provides a method of determining priority levels associated with download requests on data types. In at least some embodiments, the method is performed by a vehicle, such as vehicle 100 shown in FIG. 1, or a processor of an integrated circuit including sections for performing certain operations, such as the processor 662 shown in FIG. 6, which will be explained hereinafter.

At S330, the determining section of the processor determines a data type and detects a vehicle state. In at least some embodiments, the performing section determines vehicle state of the vehicle based on sensor data. In at least some embodiments, the determining section determines a priority level associated with each of the first download request and the second download request based on the data type and the vehicle state.

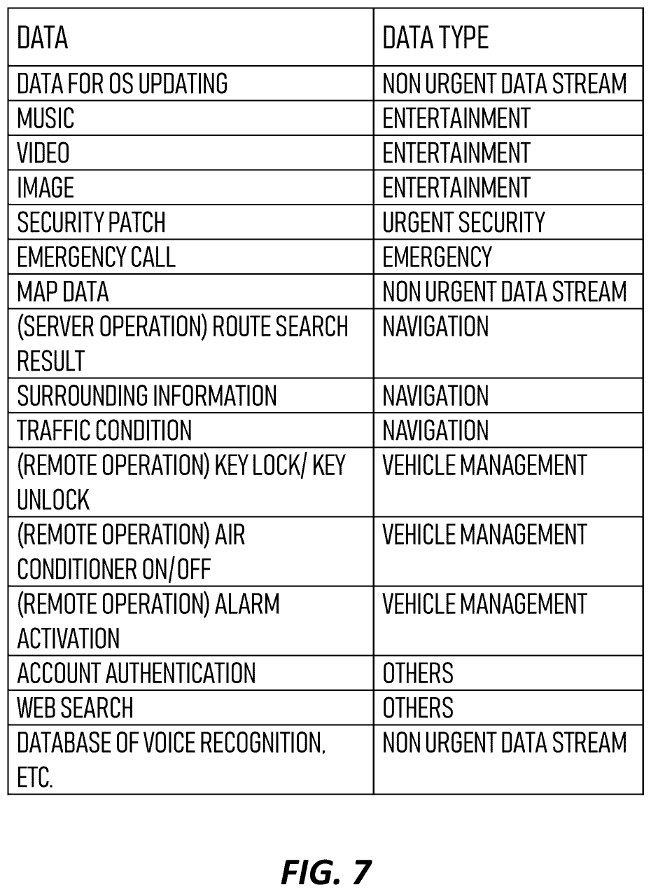

FIG. 7 is a table of an example of data types, according to at least one embodiment of the subject disclosure. The table provides an example of different data and corresponding data types. In at least some embodiments, emergency data type includes emergency call data. In at least some embodiments, urgent security data type includes security patch data. In at least some embodiments, navigation data type includes (server operation) route search result data, surrounding information data and traffic condition data. In at least some embodiments, vehicle management data type includes (remote operation) air conditioner on/off data, (remote operation) alarm activation data, and (remote operation) key lock/unlock data. In at least some embodiments, non urgent data stream data type includes data for OS updating and database of voice recognition, etc. In at least some embodiments, other data types include account authentication data, and web search data. In at least some embodiments, different types of data are prioritized according to their urgency and importance. In at least some embodiments, the processor or a section thereof maintains efficiency and performance, and enables critical services to be available, even when resources are limited. In at least some embodiments, an emergency call takes the highest priority, because an emergency call involves urgent situations where lives or safety are at risk, and delays or interruptions could have severe consequences. In at least some embodiments, real-time traffic information and online POI search are services that provide real-time data for navigation, location-based services, or user queries, which are important but not as critical as emergency calls. In at least some embodiments, media streaming services, such as video or music streaming, are valuable but not as critical as emergency services or real-time navigation. In at least some embodiments, background applications data consumes fewer resources and is less time-sensitive, making them the lowest priority.

In at least some embodiments, the vehicle state is one of running or stopped. In at least some embodiments, the vehicle state is considered to be “stopped” in cases where the vehicle transmission is in “Park”, “Neutral”, or otherwise not engaged with a gear. In at least some embodiments, the vehicle state is considered to be “stopped” in cases where the vehicle motion sensor has not detected motion for a predetermined amount of time. In at least some embodiments, the vehicle state is considered to be “stopped” even though the engine is running. In at least some embodiments, the vehicle state is considered to be “running” in cases where the vehicle is not considered to be “stopped”.

At S332, the processor or a section thereof determines whether a specified priority level is included. In at least some embodiments, the processor or the section thereof determines whether the first download request and the second download request include specified priority levels. In at least some embodiments, at least one of the first download request and the second download request includes a specified priority level. In at least some embodiments, a priority is specified in the download request, such as by a user, the operating system, or an application (including default and third party) issuing the download request. In at least some embodiments, the vehicle considers the specified priority in addition to the type of data of the download request. In response to the processor determining that the specified priority level is included, the operational flow proceeds to determination of whether the specified priority level is higher than a threshold level at S334. In response to the processor determining that the specified priority level is not included, the operational flow proceeds to determination of priority level based on the data type and the vehicle state at S338.

At S334, the processor or a section thereof determines whether the specified priority level is higher than the threshold level. In response to the processor determining that the specified priority level is not higher than the threshold level, the operational flow proceeds to determination of priority level based on the data type, the vehicle state and the specified priority level at S335. In response to the processor determining that the specified priority level is higher than the threshold level, the operational flow proceeds to ignoring the specified priority level at S336.

At S335, the determining section determines the priority level based on the data type, the vehicle state and the specified priority level. In at least some embodiments, the determining section determines the priority level of each of the first download request and the second download request further based on the specified priority level, in response to determining at least one of the first download request and the second download request includes a specified priority level. In response to the processor the priority level based on the data type, the vehicle state and the specified priority level, the operational flow ends.

At S336, the processor or a section thereof ignores the specified priority level. In at least some embodiments, the processor or the section thereof ignores the specified priority level in response to the specified priority level being higher than a threshold priority level. In at least some embodiments, the priority level specified by the download request has an upper limit value, which is lower than the priority level assigned to an emergency call.

At S338, the determining section determines the priority level based on the data type and the vehicle state. In at least some embodiments, the determining section determines the priority levels of the first download request and the second download request based on the data type and the vehicle state. In at least some embodiments, the vehicle state is one of running or stopped. In at least some embodiments, when the vehicle is running, the priorities assigned to first types of data (e.g., data relating to navigation) are made higher than the priorities assigned to second types of data (e.g., data relating to entertainment). In at least some embodiments, when the vehicle is stopped, the priorities assigned to the second types of data are made higher than the priorities assigned to the first types of data. In at least some embodiments, priority level is a matrix with data type on one axis and vehicle state on another axis.

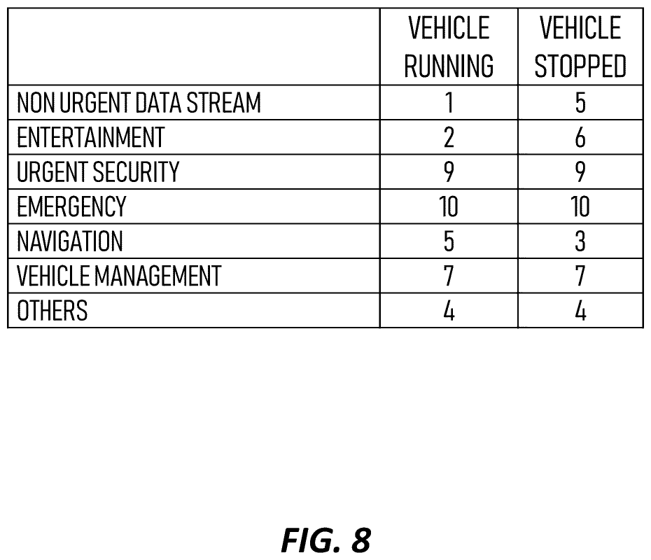

FIG. 8 is a table of an example of priority matrix, according to at least one embodiment of the subject disclosure. The table provides an example of priority matrix of different data types under different vehicle states. In at least some embodiments, an example of data priority level ranking is Emergency Call>>Real Time Traffic Info, Online POI search, etc.>>Media Streaming >>Background Applications. In at least some embodiments, the emergency data type has the highest priority ranking followed by the urgent security data type and the vehicle management data type under each vehicle state. In at least some embodiments, the navigation data type has a higher priority ranking under the vehicle state of running than the vehicle state of stopped. In at least some embodiments, the entertainment data type has a higher priority ranking under the vehicle state of stopped than the vehicle state of running. In at least some embodiments, the non urgent data stream data type has a higher priority ranking under the vehicle state of stopped than the vehicle state of running.

FIG. 4 is an operational flow for performing downloads in sequence based on associated priority levels, according to at least one embodiment of the subject disclosure. The operation flow provides a method of performing downloads in sequence based on associated priority levels. In at least some embodiments, the method is performed by a vehicle, such as vehicle 100 shown in FIG. 1, or a processor of an integrated circuit including sections for performing certain operations, such as the processor 662 shown in FIG. 6, which will be explained hereinafter.

At S440, the processor or a section thereof determines whether the vehicle is in a power saving mode, or whether a remaining capacity of a vehicle battery is lower than a threshold capacity. In response to the processor determining that the vehicle is in the power saving mode, or that the remaining capacity is lower than the threshold capacity, the operational flow proceeds to determining whether the priority level is lower than a predetermined level at S442. In response to the processor determining that the vehicle is not in the power saving mode, and that the remaining capacity is not lower than the threshold capacity, the operational flow proceeds to comparing the priority levels of the first download request and the second download request at S446.

At S442, the processor or a section thereof determines whether the priority level is lower than the predetermined level. In at least some embodiments, the processor or the section thereof determines if there is any download request associated with a priority level that is lower than a predetermined priority level. In response to the processor determining that the priority level is lower than the predetermined level, the operational flow proceeds to forgoing the download at S444. In response to the processor determining that the priority level is not lower than the predetermined level, the operational flow proceeds to comparing the priority levels of the first download request and the second download request at S446.

At S444, the processor or a section thereof forgoes the download. In at least some embodiments, the processor or the section thereof forgoes the download of any download request associated with a priority level lower than a predetermined priority level in response to the remaining capacity being lower than a threshold capacity. In at least some embodiments, when a remaining capacity of a battery of the vehicle is equal to or less than a threshold value, download of data types having a priority equal to or less than a predetermined value is prohibited, even where there is only one download request. In at least some embodiments, the processor or the section thereof forgoes the download of any download request associated with a priority level lower than a predetermined priority level in response to determining that the vehicle is in a power saving mode. In at least some embodiments, when the vehicle is in a power saving mode, download of data types having a priority equal to or less than a predetermined value is prohibited, even where there is only one download request. In at least some embodiments, the predetermined priority value when the vehicle is in a power saving mode is not necessarily the same as the one in the situation where remaining capacity of a battery of the vehicle is low. In response to the processor forgoing the download, the operational flow ends.

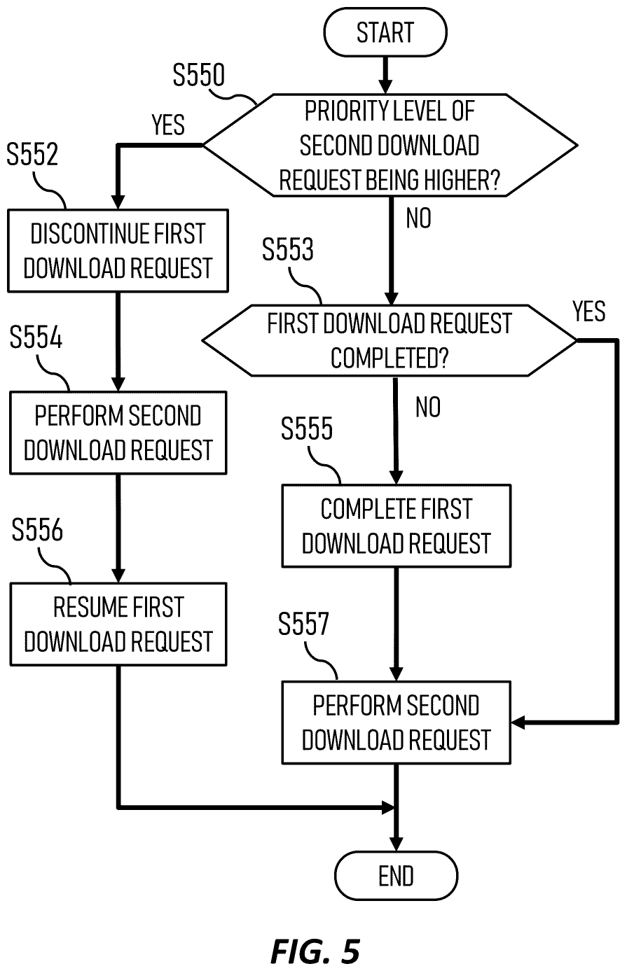

At S446, the processor or a section thereof compares the priority levels of the first download request and the second download request. In at least some embodiments, the processor or the section thereof compares the priority level of the second download request with the priority level of the first download request. In at least some embodiments, the processor or the section thereof performs the operations shown in FIG. 5, which will be explained hereinafter.

FIG. 5 is an operational flow for comparing priority levels of download requests, according to at least one embodiment of the subject disclosure. The operation flow provides a method of comparing priority levels of download requests. In at least some embodiments, the method is performed by a vehicle, such as vehicle 100 shown in FIG. 1, or a processor of an integrated circuit including sections for performing certain operations, such as the processor 662 shown in FIG. 6, which will be explained hereinafter.

At S550, the processor or a section thereof determines whether the priority level of the second download request is higher. In at least some embodiments, the processor or the section there of determines whether the priority level of the second download request is higher than the priority level of the first download request. In response to the processor determining that the priority level of the second download request is higher, the operational flow proceeds to discontinuing the first downloading request at S552. In response to the processor determining that the priority level of the second download request is not higher, the operational flow proceeds to determining whether the first download request is completed at S553.

At S552, the processor or a section thereof discontinues the first download request. In at least some embodiments, the processor or the section thereof discontinues performance of a download of the first download request in response to receiving the second download request. In response to the processor discontinuing performance of the download of the first download request, the operational flow proceeds to performing the second download request at S554.

At S553, the processor or a section thereof determines whether the first download request is completed. In response to the processor determining that the first download request is completed, the operational flow proceeds to performing the second download request at S557. In response to the processor determining that the first download request is not completed, the operational flow proceeds to completing the first download request at S555.

At S554, the performing section performs the second download request. In at least some embodiments, the performing section performs and completes the download performance of the second download request after discontinuing the performance of the download of the first download request. In response to the performing section completing the performance of the download of the second download request, the operational flow proceeds to resuming the first download request at S556.

At S555, the performing section completes the first download request. In at least some embodiments, the performing section completes the performance of the first download request. In at least some embodiments, the performing section completes the performance of the first download request before starting the performance of the second download request, in response to the priority level of the second download request is not higher than the first download request. In response to the performing section completing the performance of the first download request, the operational flow proceeds to performing the second download request at S557.

At S556, the performing section resumes the first download request. In at least some embodiments, the performing section resumes the performance of the download of the first download request in response to completing performance of the second download request. In response to the processor resuming the first download request, the operational flow ends.

At S557, the performing section performs the second download request. In at least some embodiments, the performing section performs the download performance of the second download request after completing the download performance of the first download request.

FIG. 6 is a block diagram of a hardware configuration for downloading data based on priorities, according to at least some embodiments of the subject disclosure.

The exemplary hardware configuration includes mobile computing network 660, which interacts with touchscreen display 690 directly or through network 692. In at least some embodiments, mobile computing network 660 is a network of a computer or other computing device of a vehicle that receives input or commands from touchscreen display 690. In at least some embodiments, mobile computing network 660 is a computer system that executes computer-readable instructions to perform downloads based on priorities.

Mobile computing network 660 includes a processor 662, a storage unit 670, an input/output interface 680, and a communication interface 682. In at least some embodiments, processor 662 is a processor or programmable circuitry executing instructions to cause the processor or programmable circuitry to perform operations according to the instructions. In at least some embodiments, processor 662 includes analog or digital programmable circuitry, or any combination thereof. In at least some embodiments, processor 662 includes physically separated storage or circuitry that interacts through a protocol. In at least some embodiments, storage unit 670 includes a non-volatile computer-readable medium capable of storing executable and non-executable data for access by processor 662 during execution of the instructions. Communication interface 682 transmits and receives data from network 692. Input/output interface 680 connects to various input and output units, such as touchscreen display 690, via a parallel port, a serial port, a keyboard port, a mouse port, a monitor port, a touch screen, a connection with a mobile device and the like to accept commands and present information. In some embodiments, storage unit 670 is external from mobile computing network 660.

Processor 662 includes receiving section 664, determining section 666, and performing section 668. Storage unit 670 includes download requests 672, priority levels 674, and sensor data 676.

Receiving section 664 is the circuitry or instructions of processor 662 configured to receive download requests. In at least some embodiments, receiving section 664 is configured to receive a first download request and a second download request. In at least some embodiments, receiving section 664 utilizes information in storage unit 670, such as download requests 672 and priority levels 674. In at least some embodiments, receiving section 664 includes sub-sections for performing additional functions, as described in the foregoing flow charts. In at least some embodiments, such sub-sections are referred to by a name associated with a corresponding function.

Determining section 666 is the circuitry or instructions of processor 662 configured to determine priority levels. In at least some embodiments, determining section 666 is configured to determine a priority level associated with each of the first download request and the second download request based on a data type. In at least some embodiments, determining section 666 is configured to determine a priority level further based on a vehicle state. In at least some embodiments, determining section 666 is configured to determine a priority level further based on a specified priority level. In at least some embodiments, determining section 666 is configured to ignore the specified priority level in response to the specified priority level being higher than a threshold priority level. In at least some embodiments, determining section 666 utilizes information in storage unit 670, such as download requests 672, priority levels 674 and sensor data 676. In at least some embodiments, determining section 666 includes sub-sections for performing additional functions, as described in the foregoing flow charts. In at least some embodiments, such sub-sections are referred to by a name associated with a corresponding function.

Performing section 668 is the circuitry or instructions of processor 662 configured to perform downloads of the download requests. In at least some embodiments, performing section 668 is configured to perform downloads of the first download request and the second download request in sequence based on the associated priority level. In at least some embodiments, performing section 668 is configured to perform a download of the first download request before receiving the second download request. In at least some embodiments, performing section 668 is configured to discontinue performance of a download of the first download request in response to receiving the second download request, and resume performance of the download of the first download request in response to completing performance of the second download request. In at least some embodiments, performing section 668 is configured to forgo the download of any download request associated with a priority level lower than a predetermined priority level in response to the remaining capacity being lower than a threshold capacity. In at least some embodiments, performing section 668 is configured to forgo the download of any download request associated with a priority level lower than a predetermined priority level in response to determining that the vehicle is in a power saving mode. In at least some embodiments, performing section 668 utilizes information in storage unit 670, such as download requests 672 and priority levels 674. In at least some embodiments, performing section 668 includes sub-sections for performing additional functions, as described in the foregoing flow charts. In at least some embodiments, such sub-sections are referred to by a name associated with a corresponding function.

In at least some embodiments, the apparatus is another device capable of processing logical functions in order to perform the operations herein. In at least some embodiments, the processor and the storage unit need not be entirely separate devices, but share circuitry or one or more computer-readable mediums in some embodiments. In at least some embodiments, the storage unit includes a hard drive storing both the computer-executable instructions and the data accessed by the processor, and the processor includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of a processor responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network and/or a wireless network. In at least some embodiments, the network includes copper transmission cables, optical transmission fibers, wireless transmission, routers, firewalls, switches, gateway computers and/or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In at least some embodiments, the computer readable program instructions are executed entirely on the user's computer, partly on the user's computer, as a stand-alone software package, partly on the user's computer and partly on a remote computer or entirely on the remote computer or server. In at least some embodiments, in the latter scenario, the remote computer is connected to the user's computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the subject disclosure.

While embodiments of the subject disclosure have been described, the technical scope of any subject matter claimed is not limited to the above described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

In at least some embodiments, downloading data based on priorities is performed by receiving, by a mobile computing network in a vehicle, a first download request; receiving, by the mobile computing network, a second download request; determining a priority level associated with each of the first download request and the second download request based on a data type; and performing downloads of the first download request and the second download request in sequence based on the associated priority level.

The foregoing outlines features of several embodiments so that those skilled in the art would better understand the aspects of the present disclosure. Those skilled in the art should appreciate that this disclosure is readily usable as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that various changes, substitutions, and alterations herein are possible without departing from the spirit and scope of the present disclosure.

What is claimed is:

1. A method comprising:
receiving, by a mobile computing network in a vehicle, a first download request;
receiving, by the mobile computing network, a second download request;
determining a priority level associated with each of the first download request and the second download request based on a data type; and
performing downloads of the first download request and the second download request in sequence based on the associated priority level.

2. The method of claim 1, further comprising performing a download of the first download request before receiving the second download request,
wherein the performing the downloads in sequence includes:
discontinuing performance of a download of the first download request in response to receiving the second download request, and
resuming performance of the download of the first download request in response to completing performance of the second download request.

3. The method of claim 1, wherein the determining the priority level is further based on a vehicle state.

4. The method of claim 3, wherein the vehicle state is one of running or stopped.

5. The method of claim 1, wherein
at least one of the first download request and the second download request includes a specified priority level; and
the determining the priority level is further based on the specified priority level.

6. The method of claim 5, wherein the determining the priority level includes ignoring the specified priority level in response to the specified priority level being higher than a threshold priority level.

7. The method of claim 1, further comprising detecting a remaining capacity of a battery of the vehicle,
wherein the performing the downloads in sequence includes forgoing the download of any download request associated with a priority level lower than a predetermined priority level in response to the remaining capacity being lower than a threshold capacity.

8. The method of claim 1, wherein the performing the downloads in sequence includes forgoing the download of any download request associated with a priority level lower than a predetermined priority level in response to determining that the vehicle is in a power saving mode.

9. A device comprising:
a processor including circuitry configured to
receive, by a mobile computing network in a vehicle, a first download request;
receive, by the mobile computing network, a second download request;
determine a priority level associated with each of the first download request and the second download request based on a data type; and
perform downloads of the first download request and the second download request in sequence based on the associated priority level.

10. The device of claim 9, wherein the processor is further configured to perform a download of the first download request before the processor receives the second download request,
wherein the processor performs the downloads in sequence includes:
discontinue performance of a download of the first download request in response to receiving the second download request, and
resume performance of the download of the first download request in response to completing performance of the second download request.

11. The device of claim 9, wherein the processor determines the priority level further based on a vehicle state.

12. The device of claim 11, wherein the vehicle state is one of running or stopped.

13. The device of claim 9, wherein
at least one of the first download request and the second download request includes a specified priority level; and
the processor determines the priority level further based on the specified priority level.

14. The device of claim 13, wherein the processor determines the priority level includes the processor being further configured to ignore the specified priority level in response to the specified priority level being higher than a threshold priority level.

15. The device of claim 1, wherein the processor is further configured to detect a remaining capacity of a battery of the vehicle,
wherein the processor performs the downloads in sequence includes the processor being further configured to forgo the download of any download request associated with a priority level lower than a predetermined priority level in response to the remaining capacity being lower than a threshold capacity.

16. A non-transitory computer-readable medium having instructions recorded thereon that are executable by one or more processors to perform operations comprising:
receiving, by a mobile computing network in a vehicle, a first download request;
receiving, by the mobile computing network, a second download request;
determining a priority level associated with each of the first download request and the second download request based on a data type; and
performing downloads of the first download request and the second download request in sequence based on the associated priority level.

17. The non-transitory computer-readable medium of claim 16, wherein the operations further comprise performing a download of the first download request before receiving the second download request,
wherein the performing the downloads in sequence includes:
discontinuing performance of a download of the first download request in response to receiving the second download request, and
resuming performance of the download of the first download request in response to completing performance of the second download request.

18. The non-transitory computer-readable medium of claim 16, wherein the determining the priority level is further based on a vehicle state.

19. The non-transitory computer-readable medium of claim 18, wherein the vehicle state is one of running or stopped.

20. The non-transitory computer-readable medium of claim 16, wherein
at least one of the first download request and the second download request includes a specified priority level; and
the determining the priority level is further based on the specified priority level.
